(19) United States
(12) Patent Application Publication
(10) Pub. No.: US 2025/0206387 A1
(43) Pub. Date: Jun. 26, 2025

(54) REAR SPOILER DEVICE FOR A COMMERCIAL VEHICLE

(71) Applicant: ZF CV Systems Global GmbH, Bern (CH)

(72) Inventors: Daniel Holubecki, Katy Wroclawskie (PL); Przemyslaw Kowalski, Wroclaw (PL)

(21) Appl. No.: 18/986,525

(22) Filed: Dec. 18, 2024

(30) Foreign Application Priority Data
Dec. 20, 2023 (EP) 23218405.1

(51) Int. Cl. B62D 35/00

(52) U.S. Cl. CPC B62D 35/001

(57) ABSTRACT

A rear spoiler for a commercial vehicle includes a top panel adjustable between a folded basic position and an unfolded deployed position, thereby extending a vehicle roof of the vehicle in a rearward direction. A side panel is adjustable between its folded basic position and its unfolded deployed position, thereby extending a side wall of the vehicle in the rearward direction. The rear spoiler furthermore includes an adjusting device for adjusting the top panel and the side panel between their unfolded positions and their folded positions, respectively. The adjusting device includes a single actuator and a combining mechanism driven by the single actuator. The side panel and the top panel together are adjustable by the combining mechanism, wherein the top panel and the side panel are displaceable between their positions in a predetermined sequential order relative to each other.

### CROSS-REFERENCE TO RELATED APPLICATIONS

This application claims priority of European patent application no. 23218405.1, filed Dec. 20, 2023, the entire content of which is incorporated herein by reference.

### TECHNICAL FIELD

The disclosure relates to a rear spoiler device for a commercial vehicle, in particular a towing vehicle or a trailer, and a commercial vehicle equipped with the rear spoiler device.

### BACKGROUND

Commercial vehicles generally include a box-shaped body in order to enable effective use of the available cargo space and direct access to the cargo space via rear doors provided at a rear of the vehicle. However, the box shape leads to strong vortices behind the rear of the vehicle while driving, thereby deteriorating its aerodynamic characteristics. Rear spoiler devices can be attached to the rear in order to improve the aerodynamics of the vehicle and reduce fuel consumption.

In general, commercial vehicles have at least one rear door, in particular two rear doors, that swing open rearwards and outwards; further, the rear doors can subsequently be pivoted forwards, in particular by more than 180° from the closed position, for example about 250° or 270°, in order to place them against the side walls of a box-shaped body of the vehicle and, if necessary, to lock them in place.

U.S. Pat. No. 8,382,194 B2 discloses a rear spoiler for a commercial vehicle, wherein the rear spoiler is attached to the sidewalls and to the top edge of the rear of the commercial vehicle. US 2011/0148140 A1 describes a velocity-dependent adjustment of rear air deflectors via an actuator arm. US 2015/0197292 A1 describes a further configuration of a rear spoiler device. However, these configurations are complex and not easy to attach to the vehicle body.

In the basic folded position, both panels rest on each other and on the rear doors; therefore, the deployment and folding of the two panels is controlled in order to follow a specific sequence and to avoid a collision. In general, the top panel and the side panel are driven by their own actuators, which therefore need a common control unit.

### SUMMARY

It is an object of the disclosure to provide a rear spoiler device that provides beneficial aerodynamical characteristics and a reliable adjustment between its deployed and its folded position, with relatively little effort. A further object of the disclosure is to provide a commercial vehicle equipped with such a rear spoiler device, which allows for a good accessibility of the rear doors and reliable adjustment.

The rear spoiler device according to the disclosure is for a commercial vehicle having a roof and a side wall. The rear spoiler includes: a top panel adjustable between a folded basic position and an unfolded deployed position, whereby the top panel extends the roof in a rearward direction; a side panel adjustable between a folded basic position and an unfolded deployed position wherein the side panel extends the side wall in the rearward direction; an adjusting device configured to adjust the top panel and the side panel between the respective unfolded deployed positions and the respective folded basic positions thereof; the adjusting device including: a single actuator; a combining mechanism driven by the single actuator; the side panel and the top panel being conjointly adjustable by the combining mechanism; wherein the top panel and the side panel are displaceable between the respective folded basic positions thereof and the corresponding unfolded deployed positions thereof by the combining mechanism in a predetermined sequential order relative to each other.

Further, a commercial vehicle equipped with such a rear spoiler device is provided.

Thus, a single common actuator is provided for adjusting both the top panel and the side panel. The actuator drives a combining mechanism which then actuates the two panels in a predetermined sequential order. In its folded basic position, the top panel is swiveled downwards and preferably rests on the rear door. The side panel is swiveled inwards and preferably rests on the top panel. When actuating both panels from the folded basic position, first the side panel has to be displaced in order to release the top panel, which is displaced afterwards. Both adjusting movements may overlap in time; however, an initial displacement of the side panel is necessary to release the top panel. This coordination of the displacement paths is ensured by the combining mechanism, which is driven by the single actuator.

Embodiments according to the disclosure offer several advantages. The rear spoiler system according to the disclosure is relatively cheap and has a low weight, since it uses a single actuator for both panels. Thus, the energy consumption is relatively low. The coordination of the folding and unfolding movements and pathways by the combining mechanism is safe and reliable.

Furthermore, the rear spoiler system according to the disclosure is fast to deploy and fast to fold, thereby minimizing operator delays. The adjusting device can be configured with a compact, space-saving shape, for mounting it on the rear door, for example on the inner face of the rear door.

Furthermore, an autonomous or automatic pneumatic actuation is possible. In particular, an automatic deployment and folding can be provided in dependence of the driving state, wherein an automatic deployment is only provided above a velocity threshold.

The actuator may in particular be realized as a linear actuator, in particular a pneumatic or electromechanical actuator. By using a pneumatic or electromechanical actuator, damages of the panels and the adjusting device due to obstacles can be avoided; obstacles blocking one of the panels do not damage the pneumatic actuator. Further, a pneumatic actuation results in a soft displacement of the panels. The electropneumatic control of the pneumatic actuator is relatively simple, in particular with an electropneumatic valve system, for example with a 3/2-way valve.

According to an embodiment, an electric override and/or a manual override for the electropneumatic valve system is provided, for adjusting the device independent of the pneumatic control.

The adjustment device can be supported by a single base plate to be mounted on the rear door, thereby facilitating the assembly and enhancing the reliability.

According to another embodiment, three sliders are provided, an actuation slider driven by the actuator and two sliders for the two panels, which allow for a control of each panel by its own sliding means. In particular, the side panel may be actuated by a horizontal slider received on a horizontal guiding rail and the top panel is actuated by a vertical slider received on a vertical guiding rail. The actuation control slider is preferably received on the vertical guiding rail, allowing for a compact configuration and a reliable actuation.

Thus, the conceptual control mechanism of a “single actuator” is preferably based on a system of three control sliders or carriages, sliding on guiding rails, where thanks to the appropriate arrangement of the carriages and their connection by a system of, for example, levers of appropriate lengths and ratios, it is possible to obtain such a sequence of movement, where the stroke of one linear actuator will control the opening/closing of the aerodynamic panels in a certain sequence.

According to another embodiment, a dead travel or idle stroke is provided between the control sliding means and one of the further sliding means, in particular the vertical sliding means. In a first actuation phase, the pneumatically actuated actuation slider only deploys the side panel from its folded to its unfolded position; the dead travel or idle stroke prevents an actuation of the top panel. After it has ended its dead travel, the actuation slider starts actuating, for example, pushing, the vertical sliding means and thereby initializes the subsequent displacement of the folded top panel into its unfolded position. Thus, the dead travel corresponds to a retardation in time of the deployment motions.

According to another embodiment, a rack mechanism is provided for a suitable transmission and sequential order of the displacements. The pneumatic actuator steers the rack mechanism, for example, with a toothed rack, which drives a toothed wheel running on a suitable rack means. The toothed racks can be configured with specific forms, in particular as linear racks or curved racks, in particular with an L-shape, in order to realize a retarded actuation and/or dead travel.

According to a further embodiment, the combining mechanism includes a guiding box displaced by the linear actuator, wherein the guiding box defines the pathways of rods or levers of the side panel and top panel, respectively. The pathways can be defined by cut-outs or grooves in a plate, thereby realizing a cheap, reliable solution.

By realizing the combining mechanism by a system of levers, racks and/or guiding boxes or guiding means, a cheap, reliable, compact solution is realized, with sufficient degrees of freedom for configuration.

The side panels fold towards the trailer's center line, thereby leaving plenty of room to open the rear doors to a generous angle of more than 180°, in particular 250° to 270°, thereby enabling the opened rear doors to be fixed onto the side walls of the vehicle structure. Thus, easy docking with narrow ramps and traffic aisles is possible.

Both panels can be attached to the rear doors, without further connection to the vehicle structure. The panels are preferably swiveled around hinges or by hinges, in particular with a displacement of the leading edge of the panels. Such a displacement of the panels from the folded basic positions on the rear doors into actuated positions at the roof or sides allows for an actuated position with smooth aerodynamic alignment between the structure, in particular the trailer sides and roof, and the panels, with no offset at the top and the sides, thereby avoiding air turbulences in the transition area between the structure and the panels. The rear spoiler device is simple to install, with a modular configuration and possible retrofitting. Only a few fixing points are required for mounting. The rear spoiler device fits all rear swing door vehicles, in particular rear swing door trailers.

### BRIEF DESCRIPTION OF DRAWINGS

The invention will now be described with reference to the drawings wherein:

FIG. 1A is a perspective back view of a commercial vehicle trailer equipped with a rear spoiler device according to an embodiment of the disclosure, in its folded basic position;

FIG. 1B is the perspective back view of FIG. 1A with the rear spoiler device in an unfolded deployed position;

FIG. 2 is a further back view of the rear spoiler device in its unfolded deployed position;

FIG. 3 shows a block diagram of a spoiler device with linear pneumatic actuation;

FIG. 4 shows a combining mechanism according to an embodiment, in its folded basic position;

FIG. 5 shows the embodiment of FIG. 4 in its unfolded deployed position;

FIG. 6 is an enlarged view of FIG. 5;

FIG. 7 depicts a further embodiment of a combining mechanism with a carriage received in a half-profile rail;

FIG. 8 shows an embodiment of a combining mechanism;

FIG. 9A shows an embodiment combining mechanism with a rack mechanism;

FIG. 9B shows an enlarged view of the right part of FIG. 9A;

FIG. 9C shows a detail of FIG. 9B;

FIG. 10A shows an embodiment of a combining mechanism with a guiding box for defining pathways; and,

FIG. 10B shows an enlarged view of the combining mechanism of FIG. 10A.

### DETAILED DESCRIPTION

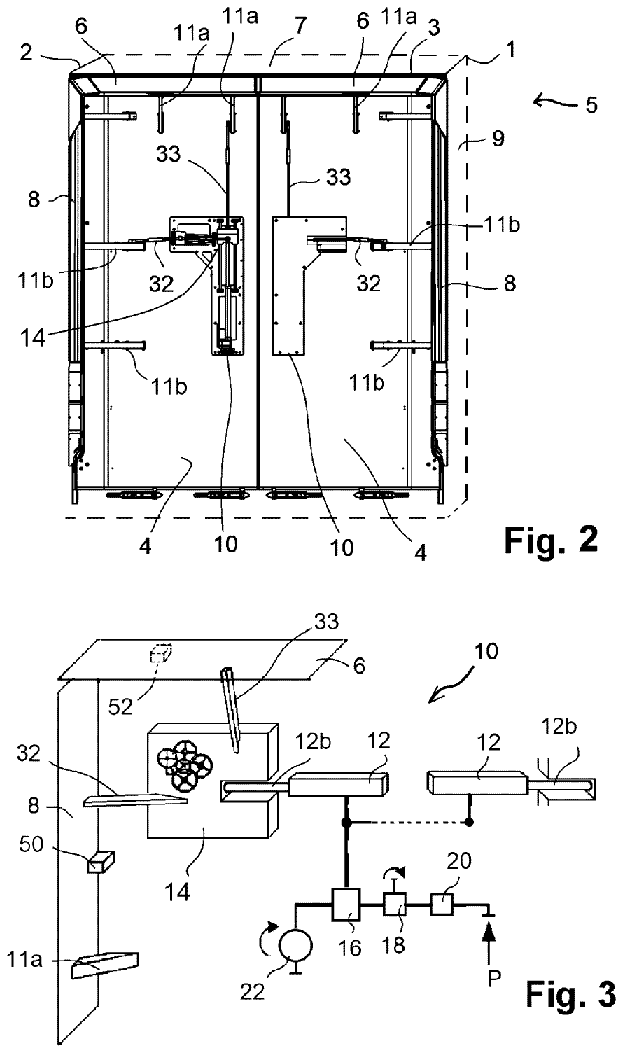

According to FIG. 2, a commercial vehicle 1 includes a substantially box-shaped vehicle structure 2, as indicated by dashed lines. A rear part 3 of the vehicle structure 2 is equipped with two rear doors (tailgates) 4. A rear spoiler device 5 is mounted on each rear door 4, respectively, as is explained hereinafter in more detail.

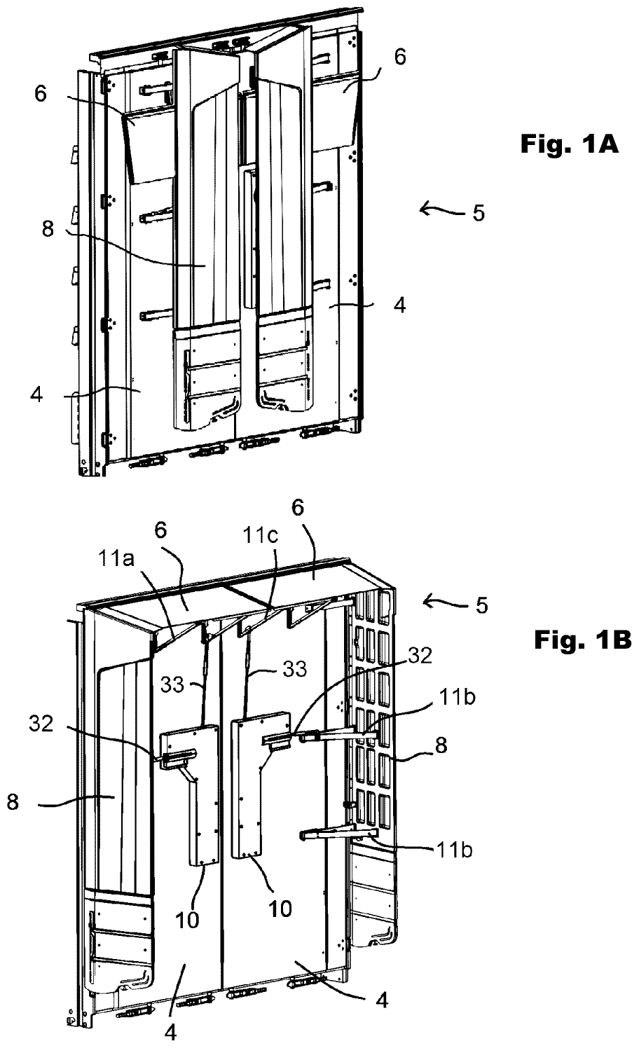

FIG. 1A shows the folded basic position of the two rear spoiler devices 5, the folded position being the basic state during standstill and when driving at lower speeds. In FIG. 1B and FIG. 2, the rear spoiler device 5 is in its unfolded, deployed state, which is autonomously adjusted at higher driving velocities. The rear spoiler devices 5 include identical or mirror-inverted parts for the left and right rear door 4, as can be seen from the figures. Each rear spoiler device 5 includes a top panel 6, which in its unfolded position of FIG. 1A and FIG. 2 extends the vehicle roof 7 in rearwards direction, in particular with an inclination downwards, for aerodynamical performance. Accordingly, each rear spoiler device 5 includes a side panel 8, which in its deployed, unfolded state of FIG. 2 extends the side wall 9 of the structure 2 rearwards, in particular with an inwards inclination, for improving an aerodynamic performance of the commercial vehicle 1.

In its folded basic position of FIG. 1A, the top panel 6 is swiveled downwards and rests on the rear door 4. In general, no spring bias is necessary for this position and adjustment into this position, since gravity is sufficient. The side panel 8 is swiveled inwards and rests on the top panel 8. In this folded basic position, the rear door 4 can be opened and pivoted or swiveled by an angle of more than 180°, for example 260°, in order to fix the rear door 4 at the side wall 9 of the structure 2. When actuating the panels 6, 8, first the side panel 8 has to be displaced in order to release the top panel 8, which is displaced afterwards. Both adjusting movements may overlap in time; however, an initial displacement of the side panel 8 is necessary to release the top panel 6 and to avoid a collision during displacement.

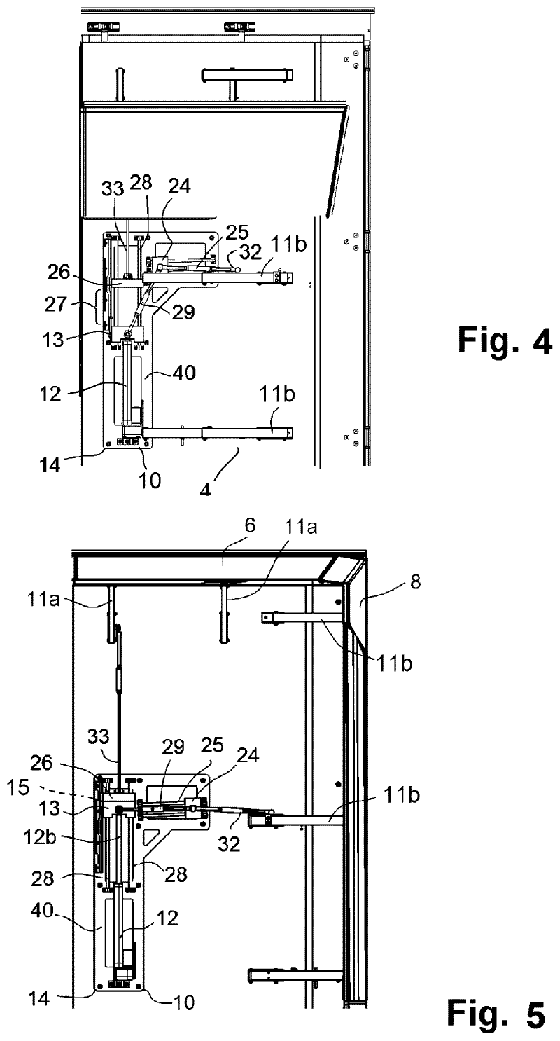

The displacement paths are coordinated by an adjusting device 10, which in particular includes a combining mechanism 14, a single linear pneumatic actuator 12 with a piston 12b and an electropneumatic control system 16, 18, 20, 22. The linear pneumatic actuator 12 drives the combining mechanism 14 and hereby shifts both, the side panel 8 and the top panel 6, in a predetermined sequential order. In FIGS. 4 to 9, various embodiments of combining mechanisms 14 are explained in detail. The combining mechanism 14 and the linear pneumatic actuator 12 are advantageously attached to the rear doors 4; the electropneumatic control system 16, 18, 20, 22 can be provided at the structure 2 or in a lift axle area of the commercial vehicle 1. The two rear spoiler devices 5 can be controlled and supplied by a single common electropneumatic control system 16, 18, 20, 22, for a simultaneous activation and reduction of hardware and costs; however, separate electropneumatic control systems 16, 18, 20, 22 are possible, for better handling by an operator.

The general configuration of the rear spoiler device 5 is depicted in FIG. 3. The actuator 12, in these embodiments a linear pneumatic actuator 12, is pneumatically controlled and drives both panels 6, 8 via the combining mechanism 14. The pneumatic actuator 12 receives pressurized air from a lift axle control valve 16, a 3/2-way cock valve 18, and a charging valve 20. The charging valve 20 is fed with pressurized air, preferably dependent on the vehicle speed. An override switch 22 allows for an electric override of this pneumatic signal, in particular by outputting a high voltage of 24 V for unfolding and either 0 V or open circuit for folding.

The combining mechanism 14 allows for an automatically controlled, combined adjustment of both panels 6, 8, without using sensors. Starting from the folded basic position of FIG. 1, the combining mechanism 14 starts the deployment of the side panel 8; the deployment of the top panel 6 is retarded in time. This retardation is preferably realized by a dead travel or idle stroke of a connection between the combining mechanism 14 and the top panel 6. The reverse actuation from the unfolded state of FIG. 2 back into the folded basic position of FIG. 1 is thus defined by a corresponding retardation. The combining mechanism 14 can be realized by a suitable lever mechanism with sliders or carriages, a rack mechanism and/or a control mechanism with cut-outs or grooves, as can be seen from the following embodiments.

FIGS. 4 and 5 depict an embodiment of a combining mechanism 14 with separate sliding paths and a dead travel. The piston 12b of the pneumatic actuator 12 is guided in a vertical guiding rail 28, together with a vertical slider 26. Thus, the head of the piston 12b serves as a vertical actuation slider 13, which uses the same vertical guiding rail 28 as the vertical slider 26, which in turn actuates the top panel 6 via a vertical rod 33. Adjustment of the side panel 8 is accomplished by a horizontal slider 24 guided in a horizontal guiding rail 25. The horizontal slider 24 is connected to the vertical actuation slicer 13 via a middle connecting lever 29 and actuates the side panel 8 via a horizontal rod 32. The guiding rails 25, 28 are provided in a base plate 40 to be mounted on the rear door 4. The specific construction of the combining mechanism 14 secures the actuation sequence of the panels 6, 8.

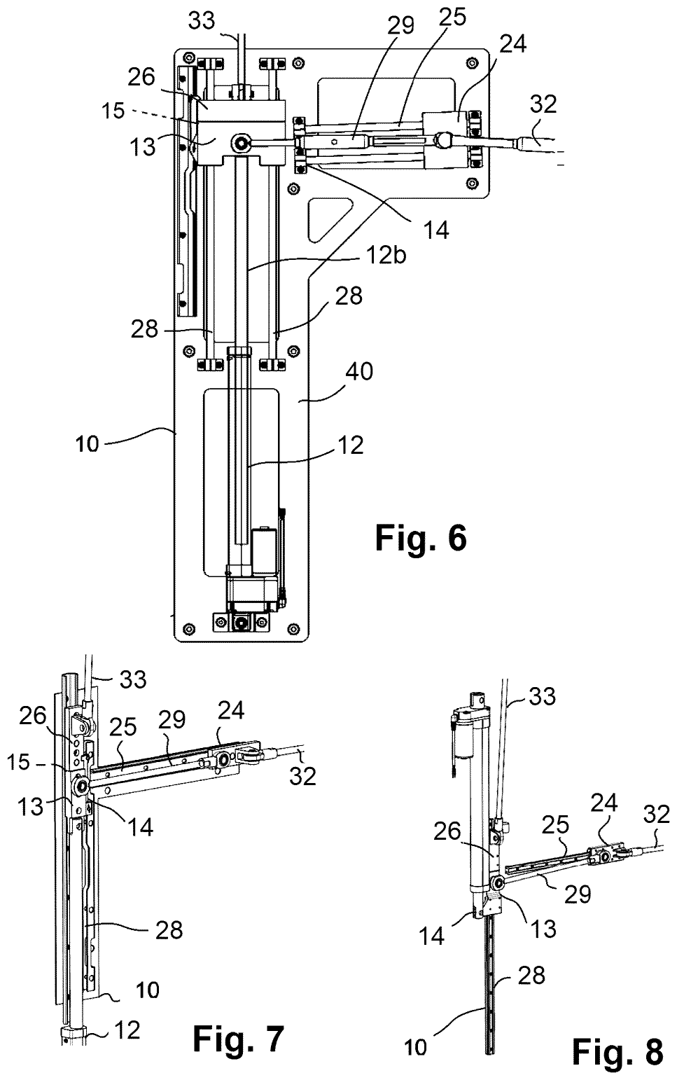

In the folded basic position of FIG. 4, the side panel 8 covers the top panel 6. Thus, when shifting into the actuated deployed position of FIGS. 1B, 2, 5, and 6, first, the side panel 8 must be swiveled, thereby uncovering the top panel 6, which is afterwards swiveled upwards. In FIG. 4, the vertical slider 26 is separated from the vertical actuation slider 13 by a dead travel 27, that is, a distance without contact. The horizontal slider 24, however, is connected to the vertical actuation slider 13 via the articulated middle connecting lever 29, which transfers the vertical upward motion of the vertical actuation slider 13 into a horizontal outwards motion of the horizontal slider 24. Thus, during the dead travel of the vertical actuation slicer 13, the side panel 8 is swiveled outwards and the top panel 8 remains in its flat basic position. When the vertical actuation slider 13 abuts on the vertical slider 26, the pivoting motion of the top panel 8 starts. Preferably, a safety locking mechanism 15 (indicated) is provided between the vertical actuation slider 13 and the vertical slider 26, in order to fix these two sliding parts, thereby also fixing the deployed top panel 6. The safety locking mechanism 15 can be realized by a hook or clamp mounted on the vertical actuation slider 13 and engaging the vertical slider 26 in the contact position of FIGS. 5, 6. Engaging and releasing of the safety locking mechanism 15 can be accomplished automatically.

In this contact position, the force transmission from the vertical actuation slider 13 to the horizontal slider 24 is advantageous, since the angle between the vertical actuation slider 13 and the horizontal slider 24 changes, which enables a higher vertical pushing force onto the vertical slider 26. The pneumatic piston 12 of this embodiment is preferably two-way actuated, allowing for an active pressurizing of the piston 12b and the vertical actuation slider in both directions, upwards and downwards.

FIGS. 7 and 8 show further embodiments of the sliding mechanism of FIGS. 4 and 5, with specific guiding rails 25, 28 and sliders 13, 24, and 26. According to FIG. 7, the vertical actuation slider 13 and the vertical slider 26 are realized as trolleys, which roll in a half-profile serving as the vertical guiding rail 28. The horizontal guiding rail 25 and horizontal slicer 24 can correspondingly be realized as a trolley-profile system. In FIG. 8, the sliders 13, 24, 26 form a kind of carriage engaging tracks or rails serving as guiding rails 25, 28.

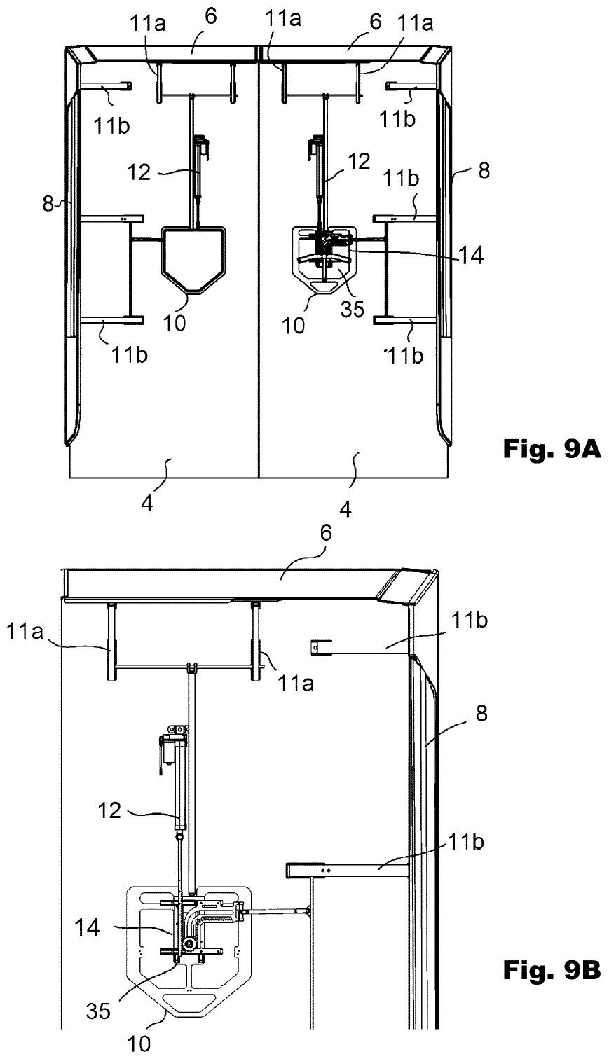

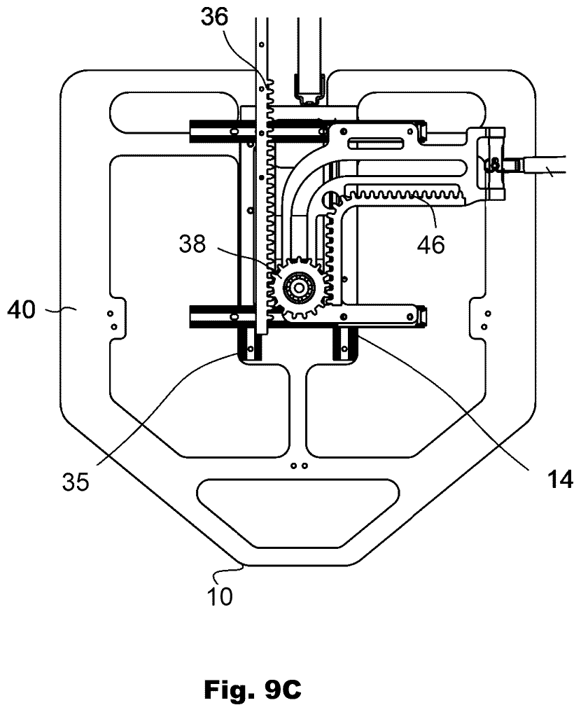

In the embodiment of FIGS. 9A, 9B, 9C, the combining mechanism 14 is realized by a rack mechanism 35. A base plate 40 is mounted on the rear door 4 or on a structure to be fitted to the rear door 4. The linear pneumatic actuator 12 is mounted on the rear door 4 or on the structure to be fitted on the rear door 4 and extends its actuation. The piston 12b of the linear pneumatic actuator 12 is connected to a linear toothed rack 36. A toothed wheel 38 is engaged with the linear rack 36, engages an L-shaped rack 46 and shifts the L-shaped rack 46 on the base plate 40 first in a vertical direction and then in a horizontal direction. The L-shaped rack 46 is fixed to a sliding plate that is connected to the side panel 8 via one of the horizontal struts 11b and to the top panel 6 via one of the vertical struts 11a.

Thus, the specific shape and position of the L-shaped rack 46 and the trajectory cut into the movable plate define the movements, with a movement dead-travel for the vertical movement.

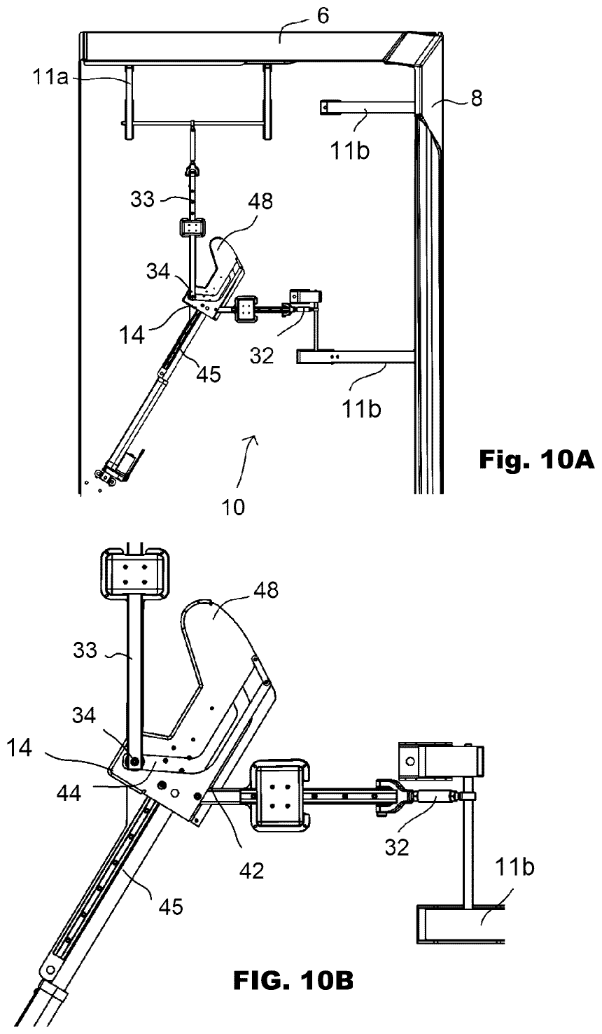

FIGS. 10A, 10B show an embodiment with a guiding box 48 for defining the motion directions and the transmission ratios of the horizontal adjustment of the side panel 8 and the vertical adjustment of the top panel 6. The guiding box 48 slides or rolls on a guiding rail 45 and includes a first cut-out 42 for an engaging pin of the horizontal rod 32 of the horizontal strut 11b of the side panel 8 and a second cut-out 44 for an engaging pin 34 of the vertical rod 33 of the vertical strut 11a of the top panel 6. Therefore, the position of the guiding box 48 and the form of the cut-outs 42, 44 define the dead travel of the vertical motion and the actuation of both panels 6, 8.

In these embodiments, the moveable parts of the combing mechanisms 14, in particular the guiding plates, guiding boxes, carriages, and trolleys, can be realized by different types and constructions. Guidings with sliders or with wheels and balls can be used. The specific angles, positions and transmission ratios between the parts can be adjusted in order to ensure a correct deployment and folding movements of the panels 6, 8. The adjusting device may be mounted onto the rear door 4 with a base plate 40, which enables a reliable and safe assembly.

The pivotal movements of the panels 6, 8 may be limited by mechanical end stops 50, 52. The panels 6, 8 may be fitted to the rear doors 4 by hinges, as per se known from the prior art.

It is understood that the foregoing description is that of the preferred embodiments of the invention and that various changes and modifications may be made thereto without departing from the spirit and scope of the invention as defined in the appended claims.

### LIST OF REFERENCE NUMERALS (PART OF THE DESCRIPTION)

1 commercial vehicle
2 vehicle structure
3 rear part
4 rear doors (tail gates)
5 rear spoiler device
6 top panel
7 vehicle roof
8 side panel
9 side wall
10 adjusting device
11a vertical strut, for the top panel 6
11b horizontal strut, for the side panel 8
12 linear pneumatic actuator
12b piston
13 vertical actuation slider
14 combining mechanism
15 safety locking mechanism
16 lift axle control valve
18 3/2-way cock valve
20 charging valve
22 override switch
16, 18, 20, 22 electropneumatic valve system
24 horizontal slider
25 horizontal guiding rail
26 vertical slider
27 dead travel
28 vertical guiding rail
29 middle connecting lever
32 horizontal rod
33 vertical rod
34 engaging pin of the vertical rod 33
35 rack mechanism
36 toothed rack
38 toothed wheel
40 base plate
42 cut-out for horizontal rod
44 cut-out for vertical rod
45 guiding rail
46 L-shaped rack
48 guiding box
50, 52 mechanical end stops

1. A rear spoiler for a commercial vehicle having a roof and a side wall, the rear spoiler comprising:
a top panel adjustable between a folded basic position and an unfolded deployed position, whereby said top panel extends said roof in a rearward direction;
a side panel adjustable between a folded basic position and an unfolded deployed position wherein said side panel extends said side wall in the rearward direction;
an adjusting device configured to adjust said top panel and said side panel between the respective unfolded deployed positions and the respective folded basic positions thereof;
said adjusting device including:
a single actuator;
a combining mechanism driven by said single actuator;
said side panel and said top panel being conjointly adjustable by said combining mechanism;
wherein said top panel and said side panel are displaceable between the respective folded basic positions thereof and the corresponding unfolded deployed positions thereof by said combining mechanism in a predetermined sequential order relative to each other.

2. The rear spoiler of claim 1, wherein in said folded basic position at least one of the following applies:
i) said top panel and said side panel extend in parallel;
ii) said side panel is positioned above said top panel; and,
iii) said side panel rests on said top panel.

3. The rear spoiler of claim 1, wherein said vehicle has a rear door and said rear spoiler is mounted on said rear door; and, said rear spoiler is configured to enable an opening and swinging of said rear door when said panels are in the folded basic positions thereof.

4. The rear spoiler of claim 1, further comprising at least one of the following:
i) at least one mechanical end stop for stopping at least one of said top panel and said side panel in said unfolded deployed position;
ii) a spring for biasing at least one of said top panel and said side panel into one of the positions or both positions; and,
iii) a base plate for mounting on said rear door with said base plate supporting said adjusting device.

5. The rear spoiler of claim 1, wherein said actuator is a linear actuator.

6. The rear spoiler of claim 5, wherein said linear actuator has a linearly shiftable piston.

7. The rear spoiler of claim 1, wherein said actuator is configured as a pneumatic actuator or an electromechanical actuator.

8. The rear spoiler of claim 7, further comprising:
an electropneumatic valve system for controlling said pneumatic actuator;
said electropneumatic valve system being being configured to vent and exhaust said pneumatic actuator; and,
said electropneumatic valve system providing an electric override via a control signal.

9. The rear spoiler of claim 8, wherein said control signal is provided by at least one of the following: a supply voltage and a manual override by an operator.

10. The rear spoiler of claim 1 wherein the combining mechanism comprises:
a vertical guiding rail;
a vertical slider received on said vertical guiding rail and connected to said top panel for adjusting said top panel;
a horizontal guiding rail; and,
a horizontal slider received on said horizontal guiding rail and connected to said side panel for adjusting said side panel.

11. The rear spoiler of claim 10, wherein at least one of said vertical slider and said horizontal slider is defined by a slider gliding on said guiding rail or a wheel carriage including wheels rolling on the guiding rail.

12. The rear spoiler of claim 10, wherein said actuator has a piston including a second vertical slider guided on said vertical guiding rail together with said vertical slider.

13. The rear spoiler of claim 10, wherein said actuator contacts or actuates said vertical slider after a dead travel and said actuator actuates said horizontal slider without dead travel.

14. The rear spoiler of claim 13, wherein said actuator is pivotably connected to said horizontal slider by a middle connecting lever.

15. The rear spoiler of claim 1, wherein said combining mechanism comprises:
a diagonally extending guiding rail and a guiding box slidably received on said diagonally extending guiding rail;
said guiding box shifting said top panel by a top connector and said side panel by a side connector; and,
said guiding box including a top pathway for said top connector and a side pathway for said side connector.

16. The rear spoiler of claim 15, wherein said guiding box is defined by a plate with cut-outs and said cut-outs defining said top pathway and said side pathway.

17. The rear spoiler of claim 1, wherein said combining mechanism includes a rack mechanism having:
a first toothed rack connected to said vertical slider;
a second toothed rack connected to said horizontal slider; and,
a toothed wheel engaged with both said toothed racks for combining displacement movements of said racks.

18. The rear spoiler of claim 17, wherein at least one of said racks includes a curved form for defining a retarded displacement.

19. The rear spoiler of claim 18, wherein said curved form is defined by an L-shaped form.

20. A commercial vehicle, comprising:
a box-shaped vehicle structure;
a rear part having a left rear door and a right rear door;
a vehicle roof and side walls;
a left rear spoiler provided on said left rear door; and, a right rear spoiler provided on said right rear door;
said rear doors being swingable from a closed position into an open position by an opening angle of more than 180°, with said rear spoilers remaining in their folded positions;
in their open positions, the rear doors being lockable at the side walls, with the folded rear spoilers received between the locked rear doors and the side walls, respectively;
in their actuated, unfolded positions, the panels extending the vehicle roof and the side walls, respectively; and,
each of said left and right rear spoilers including:
a top panel adjustable between a folded basic position and an unfolded deployed position, whereby said top panel extends said roof in a rearward direction;
a side panel adjustable between a folded basic position and an unfolded deployed position wherein said side panel extends said side wall in the rearward direction;
an adjusting device configured to adjust said top panel and said side panel between the respective unfolded deployed positions and the respective folded basic positions thereof;
said adjusting device including:
a single actuator;
a combining mechanism driven by said single actuator;
said side panel and said top panel being conjointly adjustable by said combining mechanism;
wherein said top panel and said side panel are displaceable between the respective folded basic positions thereof and the corresponding unfolded deployed positions thereof by said combining mechanism in a predetermined sequential order relative to each other.

21. The commercial vehicle of claim 20, wherein said left rear spoiler and said right rear spoiler comprise a common control system.

22. The commercial vehicle of claim 21, wherein said common control system is a common electropneumatic valve system or a common electromechanical control system.
